(19) United States
(12) Patent Application Publication
(10) Pub. No.: US 2013/0061034 A1
(43) Pub. Date: Mar. 7, 2013

(54) Transparent Mode Encapsulation

(71) Applicant: Thomas Patrick Walheim, SR., Mullica Hill, NJ (US)

(72) Inventor: Thomas Patrick Walheim, SR., Mullica Hill, NJ (US)

(73) Assignee: L-3 COMMUNICATIONS CORPORATION, New York, NY (US)

(21) Appl. No.: 13/226,651

(22) Filed: Sep. 7, 2011

(51) Int. Cl. H04L 9/00

(52) U.S. Cl. 713/150

(57) ABSTRACT

A method for providing transparent Ethernet frame adjacency may include removing a MAC addresses from a received Ethernet frame to generate a partial Ethernet frame. The partial Ethernet frame may then be encrypted. The encrypted Ethernet frame may be encapsulated in an Internet Protocol (IP) packet. The IP packet may include an indication of a Security Association (SA). The packet may be sent over a non-secure network. A device may de-encapsulate the payload of a received IP packet to generate the encrypted partial Ethernet frame. The device may decrypt the encrypted partial Ethernet frame to generate a partial Ethernet frame. The decryption device may new MAC addresses based on the SA indicated in the received IP packet. The device may append the new MAC addresses to the partial Ethernet frame such the transmitted Ethernet frame is identical to the Ethernet Frame originated at the source network device.

### BACKGROUND

Information systems that communicate sensitive information may require high levels of security. When all users of a secure information system are in the same local network or subnet, the users may connect directly via a local secure environment. However, as the number of networked devices increases, users in remote network locations may also desire access to the secure information systems. For example, a remote user may establish a secure, encrypted communications channel between the remote user and the information systems. Establishing such a connection may require a high level of security between the remote computer and the information system to protect classified or other highly sensitive data as it traverses a non-secure public network. One example of such a channel may be a High Assurance Internet Protocol Encryptor (HAIPE®) network. A HAIPE® network may create separated networking domains for secure networks (e.g., plaintext networks) and unsecure networks (e.g., ciphertext networks)

However, Internet Protocol (IP) encrypted networks, such as HAIPE® networks, may not support some networking and/or routing features. For example, security requirements may prevent covert channels which might allow certain types of communications from being communicated in an encrypted form over the non-secure public network. As an example, a router on a secure network may be unable to fully communicate with routers in other secure enclaves if the networks are connected via encryption/decryption (E/D) devices operating at Open Systems Interconnection (OSI) model Layer 3 (e.g., IP). Without such connectivity and given the fast pace of network technology development, the convergence of voice, video services, data services, and an increased dependence on robust network security, network designers may be forced make significant tradeoffs between network security, connectivity, dynamic addressing, performance, scalability, network overhead, Quality of Service (QOS) Management, and/or network resiliency (e.g., failover). As such, secure networks connected via an encrypted channel over a non-secure network may be unable to fully appreciate and make use of networking and routing functionality available in current routing technologies.

### SUMMARY

A method for providing transparent Ethernet frame adjacency for routers communicating securely over a non-secure network is disclosed. The method may be referred to as transparent mode encapsulation. The method may be implemented on an encryption device, a decryption device, an encryption/decryption device, and/or other routing device. The method may include removing a source Media Access Control (MAC) address and a destination MAC address from a received Ethernet frame to generate a partial Ethernet frame. The method may also include encrypting the partial Ethernet frame. The method may further include encapsulating the encrypted partial Ethernet frame in an Internet Protocol (IP) packet. The IP packet may include an indication of a Security Association (SA). The packet may be sent over a non-secure network. The security association may define communication parameters between an encryption device and a decryption device. The encryption and/or decryption device may associate Ethernet and/or IP addresses with the SA.

The SA associated with a received frame/packet may be determined when the Ethernet frame is received, for example based on at least one of the destination MAC address of the received Ethernet frame and/or a source MAC address of the received Ethernet frame. In another example, the SA may be determined based on at least one of a source IP address or a destination IP address of an IP packet in a payload of the received Ethernet frame.

The encapsulated partial Ethernet frame may be transmitted over a non-secure network in the Payload of an IP packet. The IP packet may be received by a decryption device. For example, the IP packet may be Encapsulating Security Payload (ESP) formatted, and an SA indication may be included in a Security Parameters Indicator (SPI) field. The decryption device may de-encapsulate the payload of a received IP packet to generate the encrypted partial Ethernet frame. The decryption device may decrypt the encrypted partial Ethernet frame to generate a partial Ethernet frame. The decryption device may determine a MAC address of a source router and a MAC address of a destination router based on the SA indicated in the received IP packet. The decryption device may form a new Ethernet frame. Forming the new Ethernet frame may include appending the determined MAC address of the source router and the determined MAC address of the destination router to the partial Ethernet frame. A new Ethernet frame checksum may be calculated. The new Ethernet frame may be forwarded to the destination router. For example, it may be sent over a secure network (or subnet) via a secure communications interface. The header of the new Ethernet frame may include routing label generated by the source router. For example, the label may be a Multiprotocol Label Switching (MPLS) label.

An encryption device, decryption device, encryption/decryption device, and/or another routing device may receive a discovery message over a non-secure network requesting a response from an adjacent router. For example, the discovery message may be an Ethernet broadcast message such as a broadcast Address Resolution Protocol (ARP) or Neighbor Discovery (ND) request. The device may compare the IP address indicated in the ARP request against the entries of a Router Map Table to determine an associated MAC address. If a match is found, the device may transmit an ARP Reply on behalf of the destination router.

A router on a secure network may exchange messages with an adjacent router as part of a routing protocol. The messages may be unicast IP packets with a Time-To-Live Value (TTL) equal to 1. The messages may have a destination MAC address associated with the adjacent router. An encryption device, decryption device, encryption/decryption device, and/or another routing device may forward the discovery request over the non-secure network to the destination router. For example, a received Ethernet frame that includes the unicast IP packet may be encapsulated and sent over the non-secure network. The exchange of these messages may be required for the routers to maintain their adjacency. For example, the routing protocol message may be a Database Description (DBD) packet.

An encryption and/or decryption device may be configured to provide secure transparent Ethernet frame adjacency for routers communicating over a non-secure network. The device may include a secure communication interface, a non-secure communication interface, secure memory, non-secure memory, an encrypt/decrypt engine, or a combination thereof. The device may demarcate an interface between a secure network and the non-secure network. The secure communication interface may be configured to communicate plaintext (PT) messages over the secure network, and the non-secure communication interface may be configured to communicate ciphertext (CT) messages over the non-secure network. The CT messages communicated over the non-secure network may be encrypted using a High Assurance Internet Protocol Encryptor (HAIPE®) protocol or Internet Protocol Security (IPSec). The device may negotiate an SA with another encryption and/or decryption device, and may associate a MAC address of a router in communication with the other encryption/decryption device with the SA. The device may also associate MAC addresses of routers in communication with the devices over a secure network (e.g., via the secure communications interface) with the SA.

In another example, transparent mode encapsulation may be implemented in a communication system performing encryption/decryption of partial Ethernet Frames from a secure network device and transmitting the resultant encrypted partial OSI Layer 2 Frames within Open Systems Interconnection (OSI) Layer 3 IP packets. The transparent mode encapsulation may make the OSI Layer 3 encryption/decryption transparent to OSI Layer 2 services. The method may include de-encapsulating a payload of a received OSI Layer 2 packet to produce a partial OSI Layer 2 frame. An OSI Layer 2 address of a non-adjacent communication device and an OSI Layer 2 address of a destination device may be determined based on a Security Association (SA) indicated in the received OSI Layer 3 packet. A new OSI Layer 2 frame may be formed. Forming the new OSI Layer 2 frame may include appending the determined OSI Layer 2 address of the non-adjacent communication device and the determined OSI Layer 2 address of the destination device to the partial OSI Layer 2 frame. The new OSI Layer 2 frame may be transmitted to a destination device, wherein the new OSI Layer 2 frame appears to the destination device to be sent from the non-adjacent communication device. In an example, the method may also include decrypting the partial OSI Layer 2 frame after de-encapsulation.

A method for facilitating discovery of routers over an IP encrypted network implemented by an encryption/decryption device is also disclosed. The method may include determining a router IP address and a MAC address for router on a common network segment to the PT interface of the encryption/decryption device. The encryption/decryption device may determine the router IP address and the router MAC address by sending a multicast request over a secure subnet requesting responses from routers with IP addresses on the secure subnet and receiving a response from the router. The response may include the router IP address and the router MAC address. For example, the multicast request may be an Internet Control Message Protocol (ICMP) router solicitation message or an Internet Control Message Protocol (ICMP) router advertisement message. An IP encrypted registration message may be sent to a router map discovery server. The registration message may include the router IP addresses and the router MAC addresses of network devices on a common network segment to the PT interface of the encryption/decryption device, as well as a secure IP address of the encryption/decryption device.

Another encryption/decryption device may discover the router after it has been registered with the router map discovery server, for example to communicate with the router over the non-secure network. To discover the router, the encryption/decryption device may query the router map discovery server for information regarding routers communicating over the non-secure network. Communications over the non-secure network may be encrypted. The encryption/decryption device may receive a response from the router map discovery server. The response may include a router IP address for the router, a router MAC address for the router, and the secure and non-secure IP addresses of IP layer encryption/decryption device acting as a gateway for the router.

An encryption/decryption device may be configured to provide virtual gateway redundancy at a secure/non-secure interface. The encryption/decryption device may include a secure communication interface, a non-secure communication interface, and a processor. The processor may be further configured to operate in one of a master state or a backup state. In the master state, the processor may be configured to forward messages received via a CT IP address from a non-secure network to a router on the secure subnet. In the master state, the processor may be configured to send a periodic heartbeat signal to the second encryption/decryption device. In the backup state, the processor may be configured to monitor for receipt of a periodic heartbeat signal from the second encryption/decryption device. In the backup state, the processor may discard received messages. The device may determine in which state to operate based on an election process.

An encryption/decryption device may provide end-to-end Quality of Service (QoS) over an IP encrypted network. The device may include a secure communication interface, a non-secure communication interface, and a processor. The processor may be configured to identify a routing label included in an Ethernet frame received via the secure communication interface. The processor may encapsulate the received Ethernet frame in an IP packet and append the routing label to the IP packet as part of a new Ethernet frame. A routing label from a secure network may be translated to a field in the non-secure IP packet header which can be used for QoS classification. For example, this field may be a Flow Label field for IP version 6. Alternatively, This field may be a DSCP field for IP version 4. The device may transmit the new Ethernet frame over an IP encrypted network via the non-secure interface. For example, the routing label identifies the IP packet as part of a packet stream. For example, the routing label may be a Multiprotocol Label Switching (MPLS) label.

### BRIEF DESCRIPTION OF THE DRAWINGS

FIG. 1 is a block diagram of an example encryption/decryption (E/D) device.

FIG. 2 is an example system diagram of E/D devices communicating via a ciphertext (CT) network.

FIG. 3 is an example PT Ethernet frame carrying a User Datagram Protocol (UDP)/IP packet.

FIG. 4 is an example flow diagram of a method for transparently encapsulating a Layer 2 Ethernet frame for communication over an encrypted network.

FIG. 5 is an example of a transparently encapsulated Ethernet frame.

FIG. 6 is an example flow diagram of a method for transparently de-encapsulating a Layer 2 Ethernet frame communicated over an encrypted network.

FIG. 7 is an example system diagram of E/D devices communicating via a CT network that includes a Router Map Discovery Server (RMDS).

FIG. 8 is an example system diagram of E/D devices communicating via a CT network configured to provide virtual gateway redundancy.

FIGS. 9A and 9B illustrate example MPLS Label translation prior to and after transparent mode encapsulation and encryption.

### DETAILED DESCRIPTION

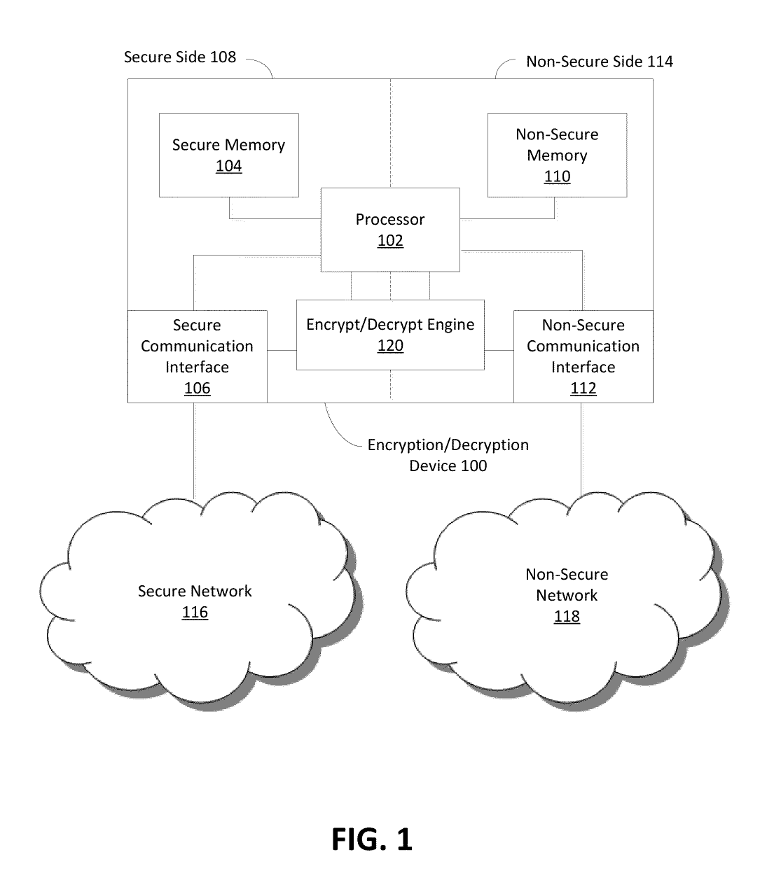

FIG. 1 is a block diagram of an example encryption/decryption (E/D) device. E/D Device 100 may be any device capable of encryption and/or decryption. E/D Device 100 may have one or more communication interfaces. E/D Device 100 may include processor 102. The processor 102 may demarcate an interface between a Secure Side 108 of E/D Device 100 and a Non-Secure Side 114 of E/D Device 100. User data or other sensitive information may be in an encrypted form when stored or communicated on Non-Secure Side 114. The encrypted data may be ciphertext (CT) data, and Non-Secure Side 114 may also be referred to as the CT side. Non-Secure Side 114 may also be known as a Black Side of E/D Device 100. Data stored or communicated on Secure Side 108 may be unencrypted. The unencrypted data may also be referred to as plaintext (PT) data, and Secure Side 108 may also be referred to as the PT side. Secure Side 108 may also be known as a Red Side of E/D Device 100. Although example internal components of E/D Device 100 are shown in FIG. 1 for purposes of illustration, E/D Device 100 may have a variety of internal configurations and may include more or less internal components then those shown in FIG. 1.

Processor 102 may be a general purpose central processing unit (CPU), a digital signal processor, a microcontroller, or the like. Processor 102 may be implemented in various ways, for example using fixed or field programmable gate logic. Processor 102 may include one or more Field Programmable Gate Arrays (FPGAs), which may be configured to perform one or more of the processes disclosed herein. For example, Processor 102 may perform encryption and/or decryption. Processor 102 may provide communication routing functions. In another example, multiple processors may be utilized. A dedicated module, engine, or device, for example Encrypt/Decrypt Engine 120, may perform encryption and/or decryption, while Processor 102 may perform other functions. Encrypt/Decrypt Engine 120 may be a separate processor, or a logical division of Processor 102. For example, data being communicated from Secure Side 108 to Non-Secure Side 114 may be encrypted by Processor 102. Similarly, data being communicated from Non-Secure Side 114 to Secure Side 108 may be decrypted by Processor 102. In another example, a module within Processor 102 and/or a separate functional block within E/D Device 100, such as Encrypt/Decrypt Device 120, may perform the encryption and/or decryption. E/D Device 100 may be configured to support Type 1 encryption. For example, E/D Device 100 may be configured to support communication via the HAIPE® protocol. E/D Device 100 may be configured to perform symmetric encryption (e.g., uses the same key to encrypt and decrypt), asymmetric encryption (e.g., uses different keys to encrypt and decrypt), public-key encryption (e.g., the publicly known key is used to encrypt and a private key is used to decrypt), manual encryption (e.g., user input may be utilized), transparent encryption (e.g., user input is not utilized), and/or the like. Encryption may be used with protocols which operate at OSI Layer 3, for example at the IP layer. An example IP layer encryption protocol may be Internet Protocol Security (IPsec). An example of an encryption algorithm that may be used is Advanced Encryption Standard (AES). E/D Device 100 may be configured to perform key establishment and/or discovery, for example communicating via Non-Secure Communication Interface 112 over Non-Secure Network 118.

Secure Side 108 may include Secure Memory 104 and/or Secure Communication Interface 106. Secure memory 104 may be a tangible computer-readable memory, for example semiconductor or solid state memory, magnetic tape, a removable computer diskette, a random access memory (RAM), a read-only memory (ROM), a rigid magnetic disk, an optical disk, a hard drive, and/or a Redundant Array of Independent Disks (RAID). Processor 102 may be configured to execute instructions stored on Secure Memory 104. Processor 102 may store data on Secure Memory 104, for example unencrypted, PT data, and/or may read data from Secure Memory 104.

Processor 102 may communicate with Secure Network 116 via Secure Communication Interface 106. Secure Network 116 may be a trusted network. Data communicated over Secure Network 116 may be in an unencrypted form. Secure Network 116 may include multiple secure subnets. The secure subnets may be a logical division of Secure Network 116. For example, computers communicating locally via network switch or router may be located on the same subnet of Secure Network 116. For example, secure routers included in Secure Network 116 may form the logical demarcation between a plurality of subnets within Secure Network 116. Secure Communication Interface 106 may be any interface capable of communication with Secure Network 116. For example, Secure Communication Interface 106 may be a network adapter. Example network adapters may include cable modems, dial-up modems, wireless network adapters, Ethernet adapters, Ethernet Network Interface Cards (NICs), and the like. Secure Communication Interface 106 may be associated with an IP address and a MAC address. For example, the IP address for Secure Communication Interface 106 may be referred to as the PT IP address for E/D Device 100.

Processor 102 may communicate with Non-Secure Network 118 via Non-Secure Communication Interface 112. Non-Secure Network 118 may be a public network. For example, Non-Secure Network 118 may be the Internet. Data communicated over Non-Secure Network 118 may be in an encrypted form. Non-Secure Network 118 may be used to communicate with other secure networks or secured devices. For example, encrypted messages may be sent to other devices over Non-Secure Network 118 via Non-Secure Communication Interface 112. Non-Secure Communication Interface 112 may be any interface capable of communication with Non-Secure Network 118. For example, Non-Secure Communication Interface 112 may be a network adapter. Example network adapters may include cable modems, dial-up modems, wireless network adapters, Ethernet adapters, Ethernet Network Interface Cards (NICs), and the like. Non-Secure Communication Interface 112 may be associated with an IP address and a MAC address. For example, the IP address for Non-Secure Communication Interface 112 may be referred to as the CT IP address for E/D Device 100.

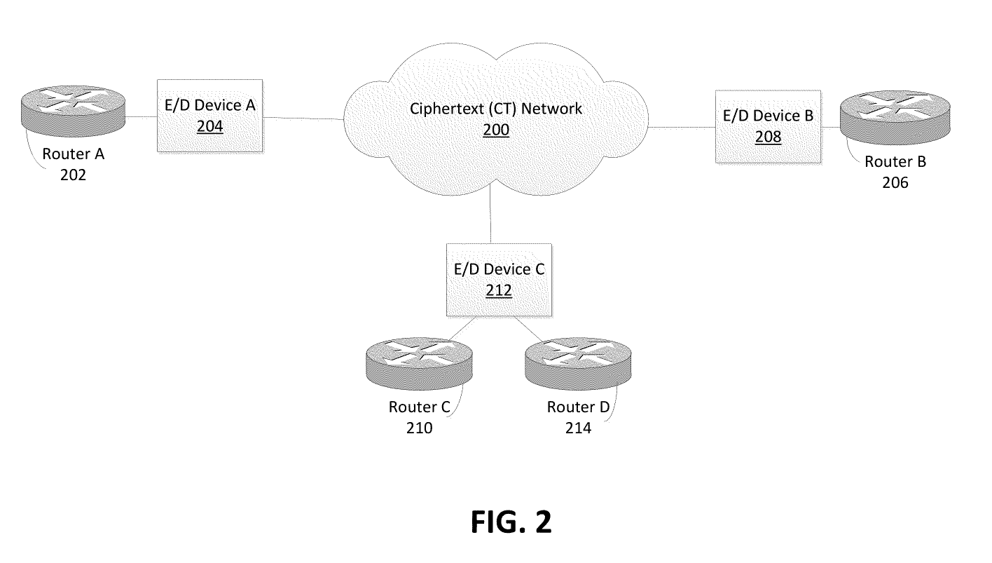

FIG. 2 is an example system diagram of E/D devices communicating via a CT network. In this example, CT Network 200 may be a public network such as the Internet. CT Network 200 may also be a private data network. Communications sent and received by E/D devices over CT Network 200 may be encrypted. As an example, three E/D devices, E/D Device A 204, E/D Device B 208, and E/D Device C 212 are shown in FIG. 2. As may be appreciated, any number of E/D devices may communicate via CT Network 200. E/D Device A 204 may communicate with devices over CT Network 200 via a non-secure communication interface, which may be associated with a MAC address and a CT IP address. Similarly, E/D Device B 208 and E/D Device C 212 may communicate with devices over CT Network 200 via a non-secure communication interface, which may be associated with MAC addresses and CT IP addresses.

The E/D Devices may establish Security Associations (SAs). Establishing an SA may involve establishing shared security attributes between two or more E/D devices. For example, E/D Device A 204 may establish an SA with E/D Device B 208. The SA may be negotiated or statically configured. An SA may include attributes such as cryptographic algorithm and mode, traffic encryption key(s), parameters for the network data to be passed over the connection, information relating to a mode of operation (e.g., Tunnel Mode, Transport Mode, Transparent Mode Encapsulation, and/or the like), or any combination of the above mentioned attributes or the like. Establishing an SA may include a cryptographic key exchange between E/D devices. An SA may also be considered a channel and logical connection that provides a secure data connection between E/D devices.

For example, SAs may be established for communication via IPSec or HAIPE®. In an example, the SA may also be associated with parameters for transparent mode encapsulation. For example, when establishing an SA between E/D Device A 204 and E/D Device B 208, the E/D devices may agree to communicate using transparent mode encapsulation. After establishing an SA, an E/D device may include in a Layer 3 (e.g., IP) header protocol field an indication that the communication is associated with the established SA. In a transparent mode encrypted CT packet, the protocol field may be set to a value that indicates that the packet has an Encapsulating Security Payload (ESP) header following the IP header. For example, the value may be 50. The field that indicates an association with the SA may be referred to as a Security Parameters Indicator (SPI) field of the ESP header. The SPI may also be referred to as a Security Parameters Index.

E/D Device A 204 may communicate with Router A 202, for example via a secure communication interface. The secure communication interface may be associated with a MAC address and a PT IP address. Communications from E/D Device A 204 to Router A 202 may be unencrypted. Router A 202 may be located on a secure subnet of a secure (PT) communication network. Similarly, E/D Device B 208 may communicate with Router B 206, for example via a secure communication interface, which may also be associated with a MAC address and PT IP address. E/D Device C 212 may communicate with Router C 210 and Router D 214, for example via a secure communication interface. The secure communication interface for E/D Device C 212 may also be associated with a MAC address and a PT IP address. Although E/D Device C 212 is shown to be in communication with two routers and E/D Device A 204 and E/D Device B 208 are in communication with one router in FIG. 2, as may be appreciated the E/D devices may be in communication with any number of routers on their respective secure sides. Router A 202, Router B 206, Router C 210 and Router D 214 may each be associated with a respective MAC address and IP address.

Standard HAIPE® network services may be primarily handled at Layer 3. For example, HAIPE® encryption may be performed at the IP level (Layer 3). An indication of an established SA may also be handled at Layer 3. In an example, the PT side of an E/D device may appear as an IP router to a secure network or secure subnet. On the non-secure side, the E/D device may appear to function as an IP host. Received Ethernet frames (Layer 2) on the PT interface may be received by the secure communication interface and classified for processing. The received Ethernet frames may be routed based on fields in the Layer 3 IP header. The frames may also be routed based on a Layer 4 header, for example in the case of port designators.

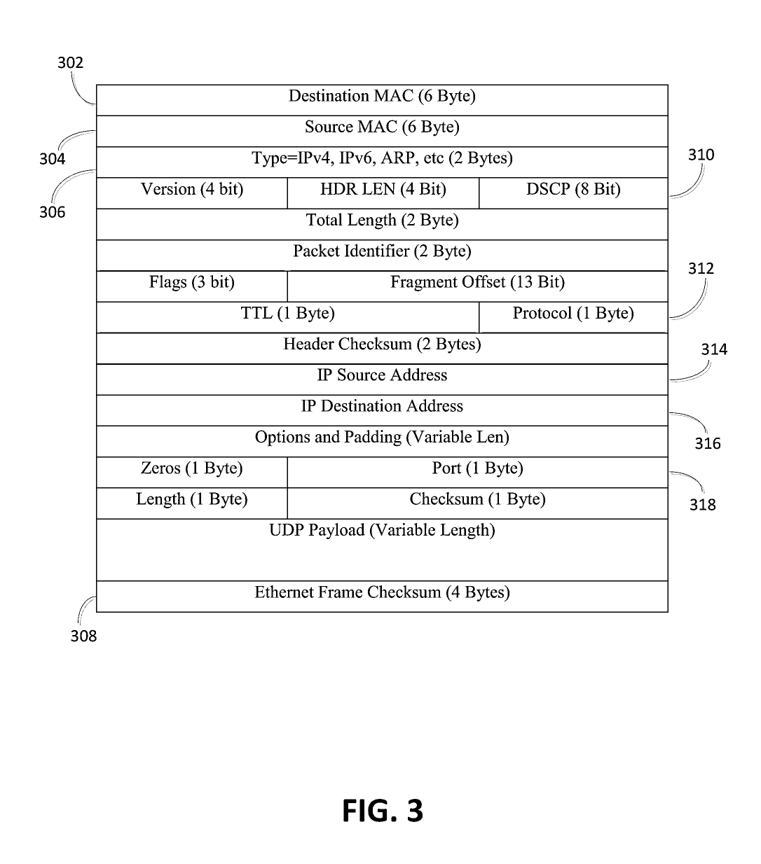

FIG. 3 is an example PT Ethernet frame carrying a User Datagram Protocol (UDP)/IP packet. For example, the Ethernet frame header may include Destination MAC address 302, Source MAC address 304, Ethernet Type field 306, and the Ethernet Frame Checksum 308. When performing HAIPE® encryption, HAIPE® packet selector information may include DSCP (Differentiated Services Code Points) field 310, Protocol field 312, IP Source Address field 314, IP Destination Address field 316, and Port field 318. These HAIPE® packet selector information fields may be available for packet classification. When performing encryption at the Layer 3 level, the Ethernet Frame may be modified at each router in the path. This may include the E/D Device's PT Interfaces. For example, for each “hop” in the routing process (e.g., for each adjacent router forming the non-secure network), the Layer 2 frame may be modified in order properly forward the message to the next router in the network. IP Packets which are destined for an adjacent network device may be transmitted with a Time-To-Live (TTL) value of one (1). This value may be decremented by each layer 3 router in the path. Routers may discard packets when the TTL value reaches zero (0). Thus, the Layer 2 frame created by the “Red” or “Secure” router prior to encryption and transmission through the non-secure network may not be received by a destination secure router when the message exits the non-secure network.

Layer 3 adjacency may be defined as the condition in which two OSI Layer 3 interfaces can communicate directly with one another without traversing intermediate Layer 3 devices (e.g. IP routers). Many routing technologies may be dependent on Layer 3 adjacency between neighbor routers. Additionally, for some routing functions a router receiving a message may expect that that device whose MAC address is listed as the Source MAC Address in the Ethernet frame is adjacent to that router receiving the frame. Based on the assumption of adjacency, the router may perform routing optimizations and increase performance or routing efficiency within the network. A router may forward packetized data from one interface to another interface based on information (e.g., addressees) in the Layer 3 packet header. However, many routing tables may specify routes in a network wherein the next hop may be required to be adjacent (e.g., on a common subnet). Once router adjacency is broken, routes between the non-adjacent routers may be deleted or stopped, and traffic over that connection may cease until the adjacency is restored.

For example, the Open Shortest Path First (OSPF) routing protocol may initially establish neighbor adjacency using multicast “Hello” packets. Each OSPF router may respond, for example using unicast traffic to establish a master/slave relationship with the router that broadcast the Hello message. The response may include an exchange of Database Description (DBD) Packets. The DBD packets may include descriptions of the routers topological database which may be used to develop the routing tables for that router. The topological database may include information related to the current network architecture from the perspective of the router. Failure to receive protocol dependent packets, such as DBD packets, and/or an acknowledgement from a neighbor may cause an OSPF router to declare that neighbor down and stop routing to it.

Multiprotocol Label Switching (MPLS) is another popular routing/switching protocol in modern networks. MPLS may be said to operate at OSI model Layer 2.5, which may be described as a hybrid of Layer 2 and Layer 3, because MPLS may insert a “header shim” between Layer 2 (e.g., Ethernet) and Layer 3 (e.g., IP). Table 1 is an exemplary MPLS protocol stack. The MPLS “shim” may contain a label which may be used throughout the network as a basis for making forwarding decisions and deciding on packet routes. In one example, the MPLS label may be the only basis used by a router when making routing decisions. In many HAIPE® implementations, because the IP header may be offset by the additional information used as part of the security protocols, a standard HAIPE® implementation may be unable to forward these packets. In other words, standard HAIPE® implementations may prevent secure routers communicating via E/D devices over a non-secure network from establishing adjacency for routing purposes.

TABLE 1
Example MPLS Protocol Stack

Layer 3 - e.g., IP
MPLS between Layer 2 and Layer 3
Layer 2 - e.g., Ethernet
Layer 1 - Physical Layer

Generic Router Encapsulation (GRE) Tunnels may be used to encapsulate some Ethernet fields, for example to simulate router adjacency across the non-secure network. GRE tunnels may create a virtual point-to-point link between two routers carrying simple unicast traffic. However, GRE tunnels may add additional overhead, for example up to 24 bytes per packet, in additional to traditional HAIPE® overhead. Additionally, the tunnel may add an additional layer of network abstraction, which may make troubleshooting the network more burdensome, adding to operational logistics and costs. Moreover, many commercial routers may be unable to perform GRE tunneling at line rate, which may limit top-rate performance Inserting GRE tunnels may also interfere with other networking feature, for example profile detection for Robust Header Compression (RoHC).

In accordance with an embodiment, to enable these network routing technologies to be implemented over an IP encrypted network, a transparent mode encapsulation may be performed. Encapsulate may mean implanting data (e.g., other packets/frames or portions thereof) in the payload of another packet and/or frame. De-encapsulating may mean retrieving a packet and/or frame (or portion thereof) from the payload of another packet and/or frame. Packet selection at network ingress to may be performed at Layer 2 (e.g., Ethernet Frame). A received Ethernet frame may include Ethernet Source and Destination Addresses, which may be removed by the E/D device upon receiving the frame from the secure network. The Ethernet Frame Checksum may also be removed. The remainder of the Ethernet frame, (e.g., the entire frame with the exception of the Ethernet Source/Destination Address/Checksum) may be forwarded through the encryption device. At secure network egress, the Ethernet addresses may be re-appended by the decryption device before it forwards the frame to a destination secure router. With the addition of a PT or secure router map table stored on E/D devices, routers may be able to fully communicate with one another as if the frame had not been passed through the non-secure network (i.e., transparently).

The transparency may enable network designers to leverage commercial router features, for example features which may require router adjacency for proper functionality. The use of a transparent encapsulation mechanism may also eliminate difficulties related to lack of interoperability with existing HAIPE® services. This capability may be provided by allowing router adjacency between PT enclaves (e.g., virtual adjacency between two secure subnets communicating via encrypted message over a non-secure network), a critical feature in most modern routing protocols, including Open Shortest Path First (OSPF), Multi-Protocol Label Switching (MPLS), Protocol Independent Multicast (PIM), as well as Virtual Local Area Network (VLAN) tagging and Community of Interest (COI) separation. Transparent mode security associations may transport Ethernet frames from one protected enclave to another. For example, traffic routed by Router A 202 to Router B 206 using the transparent mode encapsulation may be identical (e.g., from Layer 1 through Layer 7) to a communication between adjacent routers. From the perspective Router A 202 or Router B 206, E/D device, E/D Device B and CT Network 200 may be transparent.

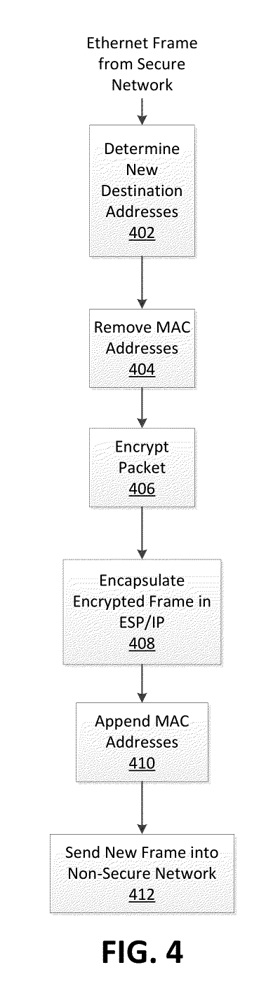

FIG. 4 is an example flow diagram of a method for transparently encapsulating a Layer 2 Ethernet frame for communication over an encrypted network. Two E/D Devices may have an established SA. The SA may include an indication that Transparent Mode Encapsulation is to be utilized. An Ethernet frame may be generated by a router or device in a secure network. The Ethernet frame may be received by one of the E/D Devices with the established SA. For example, the Ethernet frame may be received via a secure communication interface from a secure subnet. The received frame may include a Layer 3 packet to be transmitted to a device/router in communication with the other E/D Device that is part of the SA. The received frame may also be addressed to the router in the other secure enclave.

At 402, the E/D device (a.k.a., the source E/D device) may determine an address of a destination E/D device. For example, an IP address of the destination E/D device may be determined based on the destination MAC address of the received Ethernet frame, a destination IP address of a packet within the received Ethernet frame, a routing table on the E/D device, a PT router map table stored in memory on the E/D device, an established SA or any combination thereof. For example, for each potential addressee on possible secure destination subnet, a PT router map table stored on the E/D Device may include identifiers for an E/D Device PT address, a E/D Device PT Address Type, a PT Router IP Address Type, a PT Router IP Address, a PT Router MAC Address, a PT Router name. Example PT router map tables for E/D Devices A, B and C are shown in Table 2.

TABLE 2
Example PT Router Map Tables

| | E/D Device | | Router IP | | | | | |
|---|---|---|---|---|---|---|---|---|
| | PT Address | E/D Device | Address | Router IP | Router MAC | Router | CT | |
| | Type | PT Address | Type | Address | Address | Name | PMTU | Selector |
| E/D | 4 | Y.Y.Y.Y | 4 | B.B.B.B | bb:bb:bb:bb:bb:bb | Router B | 1500 | Router B |
| Device A | 4 | Z.Z.Z.Z | 4 | C.C.C.C | cc:cc:cc:cc:cc:cc | Router C | 9000 | Router C |
| | 4 | Z.Z.Z.Z | 4 | D.D.D.D | dd:dd:dd:dd:dd:dd | Router C | 9000 | Router D |
| E/D | 4 | X.X.X.X | 4 | A.A.A.A | aa:aa:aa:aa:aa:aa | Router A | 1500 | Router A |
| Device B | 4 | Z.Z.Z.Z | 4 | C.C.C.C | cc:cc:cc:cc:cc:cc | Router C | 9000 | Router C |
| | 4 | Z.Z.Z.Z | 4 | D.D.D.D | dd:dd:dd:dd:dd:dd | Router C | 9000 | Router D |
| E/D | 4 | X.X.X.X | 4 | A.A.A.A | aa:aa:aa:aa:aa:aa | Router A | 9000 | Router A |
| Device C | 4 | Y.Y.Y.Y | 4 | B.B.B.B | bb:bb:bb:bb:bb:bb | Router B | 9000 | Router B |

In the example corresponding to Table 2, E/D Device A may be in communication with Router A, for example over a secure subnet via a secure communication interface. The IP address of the secure communication interface for E/D Device A may be X.X.X.X. Router A may have a secure IP address of A.A.A.A on the secure subnet. Router a may have a MAC address of aa:aa:aa:aa:aa:aa. E/D Device B may be in communication with Router B, for example over a secure subnet via a secure communication interface. The IP address of the secure communication interface for E/D Device B may be Y.Y.Y.Y. Router B may have a secure IP address of B.B.B.B on the secure subnet. Router A may have a MAC address of bb:bb:bb:bb:bb:bb. E/D Device C may be in communication with Router C and Router D, for example over a secure subnet via a secure communication interface. The IP address of the secure communication interface for E/D Device C may be Z.Z.Z.Z. Router C may have a secure IP address of C.C.C.C on the secure subnet. Router a may have a MAC address of cc:cc:cc:cc:cc:cc. E/D Devices A, B and C may communicate via encrypted message over a non-secure network. The traditional routing tables configured on E/D Device A, B and C may include the IP and MAC addresses of the other encryption devices (e.g., The routing table of Router A may include the PT IP addresses of Router B, Router C and Router D and the ARP Cache of Router A may include the PT MAC addresses of Router B, Router C and Router D). PT IP addresses and PT MAC addresses may correspond to addresses for a non-secure communication interface.

For example, at 402 the received Ethernet frame may be used to match the source and destination MAC address to an established SA. For purposes of illustration, it may be assumed that the Ethernet frame is received by E/D Device A from Router A, and that Router A is attempting to communicate with Router B. In this example, the destination MAC address of the received Ethernet frame may be bb:bb:bb:bb:bb:bb and the destination IP address of a packet with the received Ethernet frame may be B.B.B.B. Upon receiving the Ethernet frame, E/D Device X may recognize that the MAC address bb:bb:bb:bb:bb:bb corresponds to a device communicating on a secure subnet connected to the E/D device A via the non-secure network. Based on the PT router map table (or another table stored in memory), E/D Device A may determine that E/D Device B is the corresponding E/D device for the router with MAC address bb:bb:bb:bb:bb:bb. This determination may be based on a SA between E/D Device X and E/D Device Y and/or information in the Router Map Table. E/D Device A may determine the CT IP address for the destination E/D device (e.g., E/D Device B). The CT IP address for E/D Device B may be stored, for example in a table, in memory on E/D Device A. In one example, E/D Device X may determine the PT IP address of E/D Device B based on the PT router map table, which may be store in memory. E/D Device A may then determine the CT IP address of E/D Device B based on the PT IP address, for example using another table stored in memory.

At 404, E/D Device X may remove the destination and source MAC addresses from the received Ethernet frame. For example, the removed source MAC address may be aa:aa:aa:aa:aa:aa and the removed destination MAC address may be bb:bb:bb:bb:bb:bb. The checksum may also be removed. At 406, the remainder of the received Ethernet frame (e.g., the received Ethernet frame minus the destination and source MAC addresses and checksum) may be encrypted by E/D Device A for transmission over a non-secure network. The encryption may be according to the established SA between E/D Device A and E/D Device B. For example, the protocols and encryption may be HAIPE® encryption. The encryption may be another form of protocol or encryption, such as IPsec or AES, or another form of Type 1 encryption.

At 408, the encrypted partial frame may be encapsulated into a new Layer 3 (e.g., IP) packet. For example, the Layer 3 packet may be an Encapsulating Security Payload (ESP) packet. For example, the encrypted partial Ethernet frame may be encapsulated in the UDP payload of an IP and/or ESP packet. The IP/ESP packet may be addressed to the CT IP addresses for E/D Device B. The IP packet may include an indication of the established SA. For example, an indication of the SA may be a SPI included in the ESP header. The SPI may correspond to the established SA.

At 410, E/D Device A may append new destination and source MAC addresses to the IP packet to form a new Ethernet frame. For example, the new source MAC address may be a non-secure (CT) MAC address for E/D Device A. The new destination MAC address may be determined based on the CT IP address of E/D Device B or an intermediate CT router. For example, E/D Device A may look-up what the next hop in the non-secure network is in order to forward the encapsulated Ethernet frame to E/D Device Y in a routing table stored in memory on E/D Device A. Once the next hop is identified, the new destination MAC address may be the MAC address of the non-secure router in the non-secure network that corresponds to the next hop. After appending the new MAC addresses to the IP packet with the encapsulated Ethernet frame, the Ethernet Type (indicating IPv4 or IPv6, based on the SA configuration) and Ethernet Frame Checksum fields may be populated to finalize the new Ethernet packet. At 412, E/D Device may send the new Ethernet frame into the non-secure network.

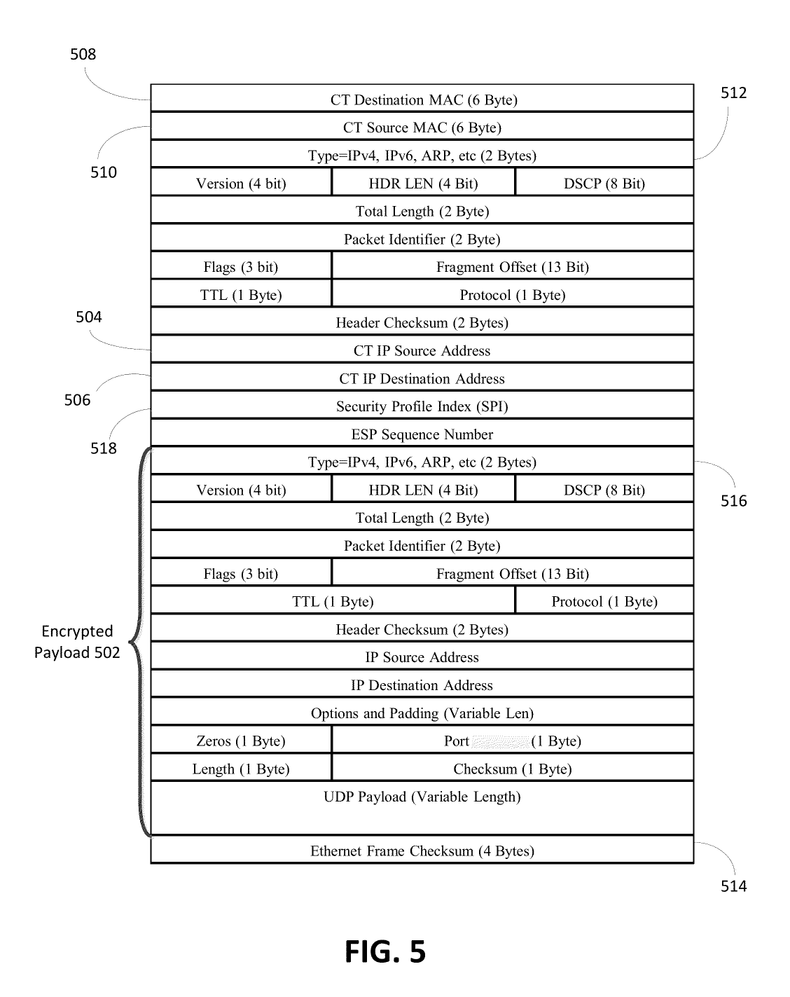

FIG. 5 is an example of a transparently encapsulated Ethernet frame. Encrypted Payload 502 may be the original Ethernet frame with the original source and destination MAC address removed. Additionally, the original Ethernet Frame Checksum (e.g., Ethernet Frame Checksum 308) may be removed. The Ethernet Frame Checksum may be part of the Encrypted Payload 502 or may be removed and re-appended at non-secure network egress. The bandwidth impact of the transparent Ethernet encapsulation relative to standard HAIPE® v3/v4 encapsulation methods may be very small. For example, for IP unicast packets, the difference may be two bytes more overhead than Tunnel Mode and two bytes less than GRE over Transport Mode (assuming common Integrity Check Value (ICV) length). When compared with GRE over tunnel mode, the Transparent Mode may be 22 bytes more efficient. Additionally, using the transparent Ethernet encapsulation may allow the transport of packets that utilize assumptions of adjacency (e.g., OSPF DBD) and packets not handled by standard HAIPE® (e.g., MPLS or 802.1Q tagged Virtual Local Area Networks (VLANs)).

Continuing with the example with respect to Table 2, the new Ethernet Header may include CT Destination MAC Address 508, CT Source MAC Address 510, Type Field 512, and Ethernet Frame Checksum 514. CT IP Source Address 504 may be the CT IP address for E/D Device X. Similarly, CT IP Destination Address 506 may be the CT IP address for E/D Device Y or of a CT network access router. CT Destination MAC Address 508 may be the non-secure MAC address for E/D Device Y or of a CT network access router (e.g., the MAC address of the router that constitutes the next “hop” in the non-secure network). CT Source MAC Address 510 may be the non-secure MAC address for E/D Device X or of a CT network access router (e.g., the MAC address of the router that constitutes the previous “hop” in the non-secure network). Type Field 512 may be utilized to indicate that encryption is present. By including Type Field 516 from the original Ethernet frame in Encrypted Payload 502, the Ethernet Frame can be reproduced in its entirety at the peer HAIPE egress interface, creating a virtual adjacency may be achieved at non-secure network egress. Security Profile Index (SPI) 518 may be set such that a destination E/D device may be able to identify a security association for the packet based on SPI 518 and/or CT IP Source Address 504.

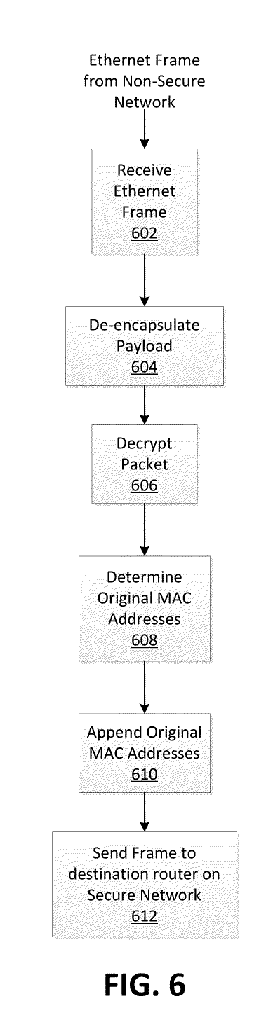

FIG. 6 is an example flow diagram of a method for transparently de-encapsulating a Layer 2 Ethernet frame communicated over an encrypted network. For purposes of illustration, FIG. 6 may be described with reference to the example PT router map table shown in Table 2. For example, at 602 E/D Device B may receive an Ethernet frame over a non-secure network via a non-secure communication interface. The Ethernet frame may include a packet with an encapsulated partial Ethernet frame sent from Router A to E/D Device A. The encapsulated partial Ethernet frame may be addressed to Router B. The packet with the encapsulated partial Ethernet frame may be referred to as a CT IP packet and/or an ESP/CT Packet. For example, the received Ethernet frame may include a destination MAC address field, and the value of the destination MAC address field may be a non-secure MAC address for E/D Device B. Upon receiving the Ethernet frame, E/D Device B may pass the packet to Layer 3 for processing. The Payload of the Ethernet frame may include an IP packet (e.g., the CT IP packet). The IP packet may include destination and source IP address fields. The source IP address field may have a value of a non-secure (CT) IP address for E/D Device A. The destination IP address field may have a value of a non-secure (CT) IP address for E/D Device B. For example, the IP Packet may have its protocol value set to 0x32 indicating that it is ESP formatted. The IP packet may have a security profile index (SPI) identifying how the payload was encrypted and that it may be encapsulated using the transparent mode encapsulation.

At 604, E/D Device B may de-encapsulate an encrypted partial Ethernet frame from the payload of the CT IP packet. The partial Ethernet frame may be missing source and destination MAC addresses and checksum. At 606, E/D Device B may decrypt the de-encapsulated encrypted partial Ethernet frame. At 608, E/D Device B may determine a new source router MAC address and destination router MAC address. For example, E/D Device B may determine the source and destination router MAC address based on the SPI field of the CT IP packet. In this example, the source MAC address of the packet encapsulated in the payload of the partial Ethernet frame may be the MAC address for Router A and the destination MAC address may be the MAC address of router B. E/D Device Y may determine the source router MAC address by consulting the (Security Association Database (SAD), which may be stored in memory.

Additionally, E/D Device Y may determine the source router MAC address based on the SPI field of the CT IP packet. For example, E/D Device Y may utilize unique destination IP addresses from the IP packet encapsulated in the payload of the partial Ethernet frame and the destination MAC address to uniquely transmit the resulting frame to the appropriate PT router, for example if there may be more than one router on the secure subnet associated with E/D Device X. E/D Device Y may determine a PT IP address (e.g., a secure IP address) for E/D Device X based on the SPI field of the CT IP packet, for example by consulting a table stored in memory. E/D Device Y may determine the source router MAC address by consulting the PT router map table, which may be stored in memory. For example, E/D Device Y may use the SPI field of the CT IP packet to determine the MAC address for Router A. E/D Device Y may use the SPI field of the CT IP packet to determine the MAC address for Router B. The determination of the Router B MAC address may also be based on an IP address of an IP packet included in the payload of the partial Ethernet frame and/or a table stored in memory.

At 610, E/D Device B may append new MAC addresses to the partial Ethernet frame. The new MAC addresses may be the same as the MAC addresses in the original Ethernet frame transmitted by Router A. For example, E/D Device B may append the determined source router MAC address (e.g., the MAC address for Router A) as a new source MAC address for the partial Ethernet packet. E/D Device B may append the determined MAC address for Router B as the new destination MAC address for the partial Ethernet packet. E/D Device B may determine the MAC address for Router B based on the SPI field of the CT ESP/IP packet and a table stored in memory. E/D Device B may compute a new Ethernet Frame Checksum. Hence, a completed new Ethernet frame may be formed. The resulting frame may be identical to the source Ethernet Frame sent by Router A. At 612, E/D Device B may send the new Ethernet frame on a secure network, for example via a secure communication interface. The new Ethernet frame may be received by Router B, which may be located on the secure subnet.

Transparent mode encapsulation may allow an E/D device to perform packet processing, cryptographic COI separation, and/or data protection while allowing the PT routers to perform the majority of the routing, dynamic addressing, load balancing and/or other routing-specific features. Transparent mode encapsulation may be performed with both current and future definitions of Ethernet payloads between PT routers and may provide an inherent investment protection and future-proofing as commercial networking technologies advance at a much faster rate than Type 1 network solutions.

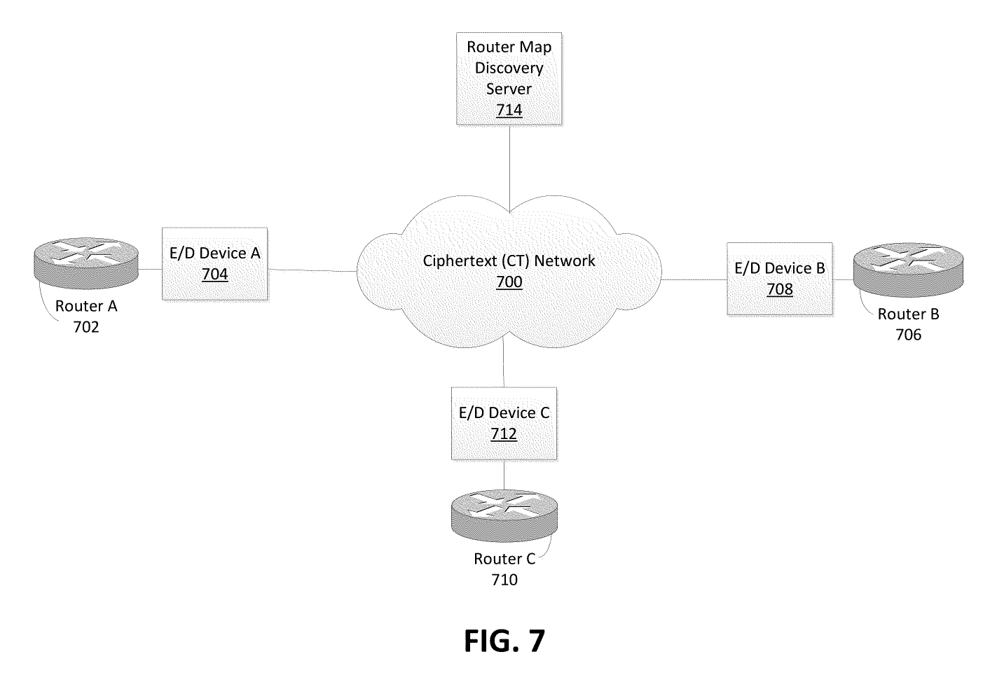

With reference to FIG. 7, to create a transparent mode communications between Router A 702, Router B 706, and Router C 710, each of the E/D devices (e.g., E/D Device A 704, E/D Device B 708, and E/D Device C 710) may successfully discover the MAC addresses of the other secure routers in communication with the other E/D devices (e.g., E/D Device A 704 may discover the MAC address of Router B 706 and Router C 710). In this way, the E/D devices may be able to simulate router adjacency to the secure routers on different secure subnets. In other words, each E/D Device may populate and store a PT router map table for the purposes of performing the encapsulation and/or de-encapsulation.

While the PT router map table may be manually configured, for example via SNMP, maintaining this table manually may be an administrative burden to network administrators on larger networks. However, the burden of manual table maintenance may be eliminated, for example by using both local and network discovery mechanisms to build a complete network level PT Router Map table.

Each E/D device (e.g., E/D Device A 704, E/D Device B 708, E/D Device C 712) may be tasked with discovering the neighbor routers on the local secure subnet including the PT interface of the respective E/D device. For example, E/D Device A 704 may discover Router A 702, E/D Device B 708 may discover Router B 706, and E/D Device C 712 may discover Router C 710. Depending on network architecture, there may be multiple routers on a given PT subnet (see e.g., FIG. 2). The E/D devices may discover the local routers on the secure subnet by sending a multicast message over the secure subnet and receiving a response from routers located on the secure subnet.

There may be standard mechanisms for E/D devices to discover routers on a secure local subnet. For example, Internet Control Message Protocol (ICMP) Router Discovery messages may be utilized for router solicitation. ICMP router discovery messages may be sent by the E/D devices to locate routers on the secure subnet. Additionally, secure routers located on the subnet may periodically send router advertisements or in response to router solicitations from an E/D device. The router advertisements may identify router interface IP addresses. The complete router advertisement frame may include the IP address and MAC address for a router on the secure subnet. The E/D device may use this advertisement to associate the router MAC address and IP address to the PT interface for the E/D device. For example, Router A 702 may send a router advertisement to E/D Device A 704, which may include the MAC address and IP address of Router A 702. E/D Device A 704 may associate the received MAC and IP addresses with the PT interface of E/D Device A 704 (e.g., The secure or PT IP address of E/D Device 704). This information may be shared with a network Router Map Discovery Server 714. Router Map Discovery Server 714 may be an E/D device, for example in communication with secure routers on a secure subnet. Although not shown in FIG. 7, Router Map Discovery Server 714 may communicate over CT Network 700 (e.g., for communications with other E/D devices) via an E/D Device. In another example, Router Map Discovery Server 714 may include encryption/decryption functionality. Router Map Discovery Server 714 may be a server communicating via encrypted messages over CT network 700. IPv6 may use similar mechanisms through Internet Engineering Task Force (IETF) Request for Comments (RFC) number 2461—Neighbor Discovery for IPv6.

To distribute and aggregate the locally discovered entries, Transparent Mode may utilize modified Generic Discovery Services (GDS), for example services introduced with HAIPE® IS v3.x. Using this model, each enabled E/D Device, having discovered the MAC and IP address of adjacent routers on the secure subnet corresponding to the E/D Device, may share this information via a registration message sent to one or more Router Map Table Discovery Servers 714. Router Map Table Discovery Server 714 may then distribute the table to each registered E/D device, for example using query and response messages as the table changes.

Since the content and structure of discovery messages may be different for standard HAIPE® generic discovery, Router Map Table Discovery Server 714 may be configured to use a different IP Address and/or Port than a standard HAIPE® server. To reduce the possibility of contention, Router Map Table Discovery Server 714 may use different message types than those in High Assurance Internet Protocol Encryption Interoperability Specifications (HAIPE IS) and may discard message types associated with that specification. With these provisions, both may be executed concurrently without conflict.

In addition to the discovery client capability, several E/D devices may be configured to act as a server for router map table discovery, for example to provide decentralized server functionality across the network. Having limited data to maintain relative to HAIPE IS Specified Generic Discovery Services (GDS), this Transparent Mode discovery service may support very large networks even when hosted internal to an E/D device. The GDS May alternatively be hosted in a secure network host external to the E/D device.

In Transparent Mode, the PT Address Resolution Protocol (ARP) processing of an E/D device may be modified such that in addition to responding to ARP messages for its PT address, the E/D may respond to ARP messages for each proxy router in its table using the actual MAC address from the configuration table. For example, if Router A 702 issued a broadcast ARP request for Router B 706, E/D Device 708 may respond with the MAC address for Router B 706 (e.g., bb:bb:bb:bb:bb:bb in the example from Table 2). In another example, if Router A 702 sent an IPv6 Neighbor Discovery (ND) message requesting identification of Router B, E/D Device 708 may respond with the MAC address for Router B 706. By doing so, virtual adjacency for Router A 702 relative to Router B 706 may be established. For example, virtual adjacency may be established between the routers on their local Ethernet interfaces, which may meet the adjacency requirements for routing protocols such as OSPF.

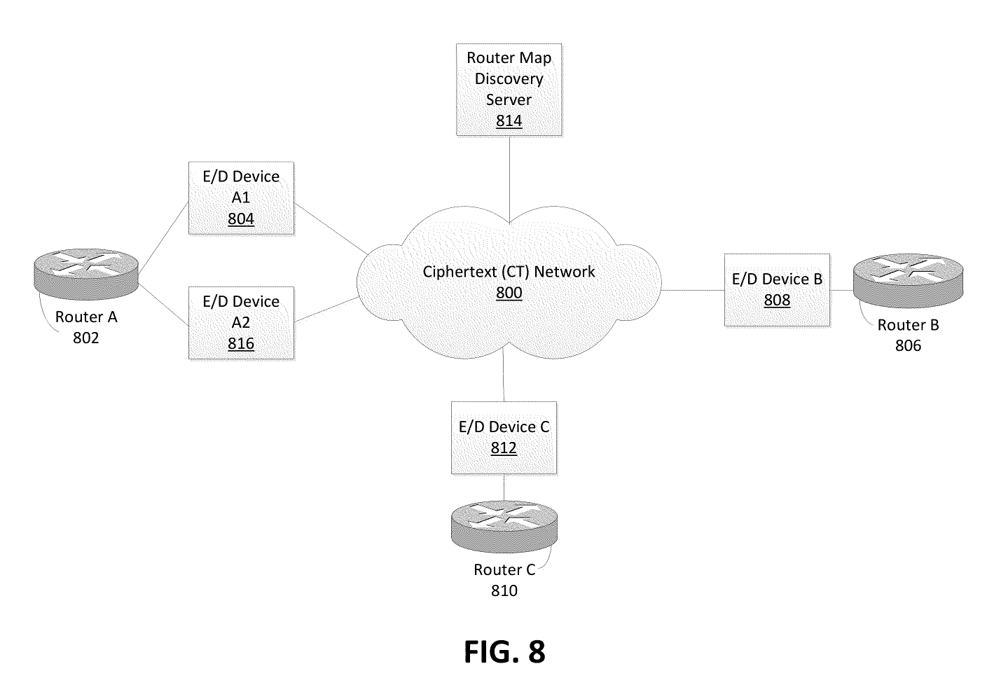

FIG. 8 is an example system diagram of E/D devices communicating via a CT network configured to provide virtual gateway redundancy. In this example, an E/D device may provide PT side redundancy so that locally connected devices may continue to use learned or configured addressing in the event one of the E/D devices malfunctions or goes offline. For example, multiple E/D devices with interfaces on a common secure subnet share a common IP address and MAC address, but one E/D device (e.g., the MASTER) forwards traffic presented on that interface. The other E/D devices (e.g., BACKUPs) may not. An election process may be used to determine the MASTER and a heartbeat between the interfaces may be used for the BACKUPs to determine the status of the MASTER. If the MASTER is determined to be down, for example, if the heartbeat message is not received by the BACKUPs for a predetermined period of time, the BACKUPs may elect a new MASTER.

In the example shown in FIG. 8, E/D Device A1 804 and E/D Device A2 816 may both for the PT/CT interface between CT Network 800 and a PT subnet including Router A 802. E/D Device A1 804 and E/D Device A2 816 may communicate via CT Network 800 with E/D Device B 808, E/D Device C 812, and/or Router Map Discovery Server 814. Although not shown in FIG. 8, Router Map Discovery Server 814 may communicate over CT Network 800 (e.g., for communications with other E/D devices) via an E/D Device. In another example, Router Map Discovery Server 714 may include encryption/decryption functionality. E/D device B 808 may communicate with Router B 806, and E/D device C 812 may communicate with Router C 810. In this network configuration, E/D Device A1 804 and E/D Device A2 816 may provide the same transparent services and logical connections to Router A 802, but if both are fully active at the same time, each Ethernet frame transmitted by Router A 802 may be duplicated for delivery to the far end Router B 806 and/or Router C 812. To eliminate this condition, E/D Device A1 804 and E/D Device A2 816 may maintain a device level state of MASTER or BACKUP. An election may take place between E/D Device A1 804 and E/D Device A2 816, for example by exchanging messages, and one of E/D Device A1 804 and E/D Device A2 816 may act as a MASTER, while the other may act as a BACKUP.

When operating in an MASTER state, an E/D device may fully operate as described above, for example by providing transparent mode connections between PT routers. When operating in a STANDBY or BACKUP state, an E/D device may discard Ethernet frames received for transparent mode services. This may be accomplished by switching the rule action for each transparent mode SA to “discard.” For purposes of illustration, it may be assumed that E/D Device A1 804 may be the MASTER and E/D Device A2 816 may be the BACKUP. Communications between Router A 802 and Router B 806 may be through SAs between E/D Device A1 804 and E/D Device B 808. E/D Device A2 816 may have active SAs with the Router Map Discovery Server 814, E/D device B 808, and/or E/D Device C 812, so it may still be able to receive updates and to maintain reachability with the other E/D devices. However, E/D Device A2 816 may drop traffic it receives for Router B 806 while in the standby state. In the reverse direction, E/D Device B 808 may have a primary SA with E/D Device A1 804 and a secondary SA with E/D Device A2 816. As long as the SA to E/D Device A1 804 is reachable as determined via HAIPE IS Specified Peer HAIPE Reachability Detection (PHRD), traffic from Router B 806 to Router A 802 may utilize that SA. This redundant configuration may be called Virtual Gateway Redundancy Protocol (VGRP). Table 3 shows example network and discovery services that may be active based on the VGRP state (e.g., MASTER or BACKUP). When used in conjunction with existing HAIPE®® Peer HAIPE® Reachability Detection (PHRD) failover techniques and commercial red-side routing techniques, a comprehensive network availability may be employed, which may reroute traffic around any redundantly protected failure in less than a few seconds and around most failures in less than a second.

TABLE 3
Example Network and Discovery Services Supported by VGRP

| | Master | Backup |
|---|---|---|
| PT Interface ARP/ND | X | X |
| Standard HAIPE ®® IP | X | X |
| Services (v4/v6) | | |
| Multicast IP services (v4/v6) | X | X-may be trimmed by |
| | | Protocol Independent |
| | | Multicast (PIM) router |
| Proxy ARP/ND | X | X (discard) |
| Forward Transparent Mode Traffic | X | X (discard) |
| Router Discovery | X | X |
| Router Map Table Discovery | X | X |
| SNMP Management | X | X |

HAIPE® may permit copying of an 8-bit field in the IP header known as Differentiated Services Code Point (DSCP). IPv6 may include a 20-bit field called a flow label which has a similar capability. For example, these fields may be used in IP routed networks to identify the traffic stream for purposes of traffic management and routing, and queuing decisions may be made in commercial routers to ensure bandwidth fairness and prioritization of high value or latency-sensitive services.

Many large enterprise and carrier networks utilize MPLS routing/switching technology to ensure delivery of varied services over a common data network backbone. In MPLS, packets may be classified by a Label Edge Router (LER) based on contents of the payload. For example, in IPv4, traffic may be classified by IP source/destination addresses, protocols or DSCP values. The ingress LER may insert the MPLS header shim into the packet and may initiate QoS reserved paths through the network through Label Switched Routers (LSRs) to the egress LER. The egress LER may remove the MPLS shim and delivers the packet. With HAIPE® separation, traffic from one enclave to another over the HAIPE® network may result in as many as three different MPLS Label Switched Paths (LSPs) for each connection with no logical mapping between them.

The CT interfaces of HAIPE® E/D devices may be designed to perform functions similar to network IP hosts. As such, a HAIPE® CT packet may not have an MPLS header, and therefore may not have an MPLS label associated with it. However, by combining existing field bypass capabilities of the HAIPE IS v3.x E/D devices with Transparent Mode Encapsulation, a translation may be performed which would allow an MPLS label (or a portion thereof in IPv4) to be preserved throughout the network.

By use of the Transparent Mode Encapsulation, the MPLS label from one enclave may be translated into a field in the outer packet directly to an IPv6 flow label. In another example, the MPLS label may be partially translated (for example, based on a configured offset) into the 8-bit CT DSCP field and then bypassed. This may allow routers on a CT network to act on the label information from the PT enclave. This approach may still create two LSPs (for example, one black/CT and one red/PT), but the MPLS routing may perform bandwidth reservation and queuing setup in the CT network. This may be because of a 1:1 mapping with PT MPLS labels and may simplify the end-to-end design and administration effort associated with QoS.

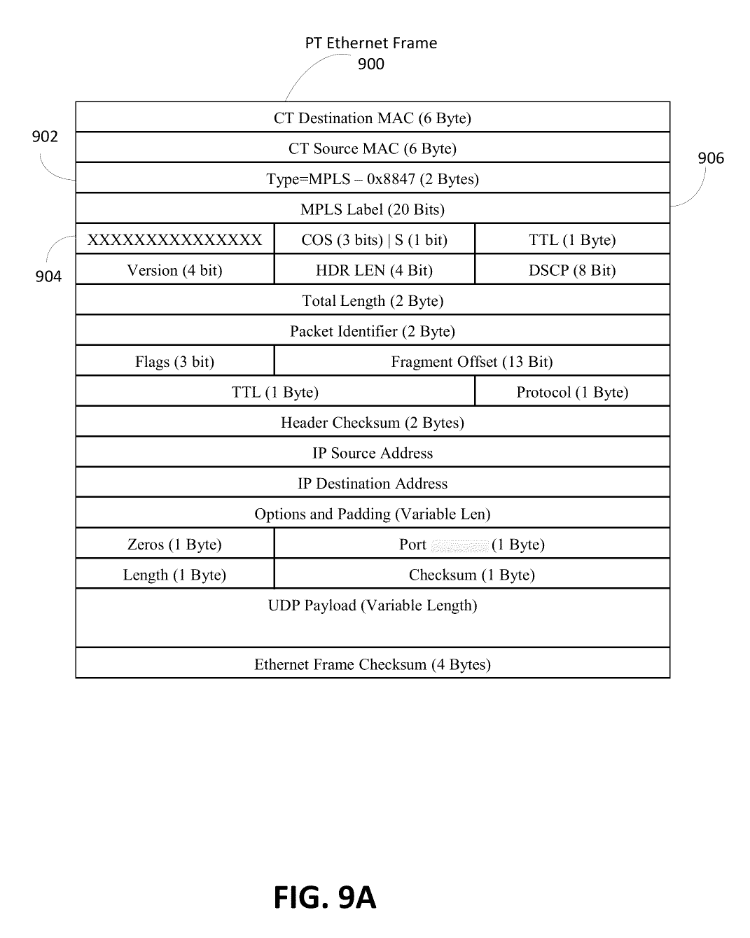

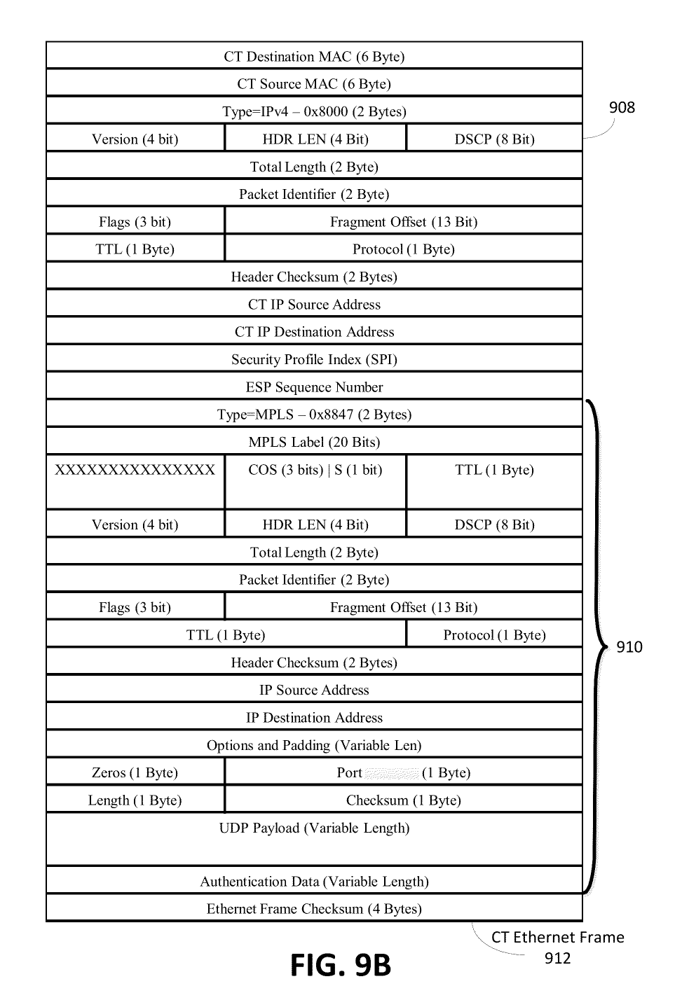

FIGS. 9A and 9B illustrate an example of an MPLS Label translation prior to and after transparent mode encapsulation and encryption at the CT interface of an encrypting E/D device. The encapsulation and encryption may be based on an IPv4Transparent Mode SA. An MPLS header shim may be added to this Ethernet frame by the PT ingress LER. For example, as shown in FIGS. 9A and 9B, PT Ethernet Frame 900 may include Type Field 902 which may be set to MPLS (e.g., 0x8847). PT Ethernet Frame 900 may also include Field 906, which may be a 20 bit MPLS routing and translation. CT Ethernet Frame 912 may include encrypted/encapsulated payload 910. Additionally, 8-bit portion of the MPLS label field 904 may be mapped to DSCP field 908 to provide MPLS label translation, which may allow QoS routing and network management inside the CT network. In another example using IPv6, the entire 20 bit MPLS label can be translated to the Flow Label in the CT IP packet.

Embodiments may take the form of a tangible computer-usable or computer-readable medium providing program code for use by or in connection with a computer or any instruction execution system. Examples of a computer-usable or computer-readable medium include tangible computer media such as semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A processor may be configured to execute instructions stored in memory to perform the various functions described herein.

Although the concepts and structures disclosed herein have been described with reference to several examples and exemplary embodiments, numerous modifications and variations may be made and still be within the scope described herein. No limitation with respect to any specific example or embodiment is intended to be necessary or mandatory, and the scope of the protection should be plainly apparent based on the language of the following claims.

What is claimed:

1. A method implemented on an encryption device for providing transparent Ethernet frame adjacency for routers communicating over a network, the method comprising:
removing a source Media Access Control (MAC) address and a destination MAC address from a received Ethernet frame to generate a partial Ethernet frame;
encrypting the partial Ethernet frame; and
encapsulating the encrypted partial Ethernet frame in an Internet Protocol (IP) packet, wherein the IP packet includes an indication of a Security Association (SA).

2. The method of claim 1, further comprising sending the IP packet over a non-secure network in accordance with the SA.

3. The method of claim 1, further comprising determining the SA based on at least one of the destination MAC address of the received Ethernet frame or the source MAC address of the received Ethernet frame.

4. The method of claim 4, further comprising determining the SA based on both of the destination MAC address of the received Ethernet frame and the source MAC address of the received Ethernet frame.

5. The method of claim 1, wherein the IP encryption is Internet Protocol Security (IPsec) encryption or High Assurance Internet Protocol Encryption Interface Specification (HAIPE IS).

6. The method of claim 1, further comprising:
determining a router IP address for a first router, wherein the source MAC address of the received Ethernet frame is a MAC address for the first router; and
sending a registration message including the router IP address for the first router, the MAC address for the first router, and a secure IP address of the encryption device to a Router Map Discovery Server.

7. The method of claim 6, further comprising receiving mapping information for at least one other router on a secure subnet that communicates using IP encryption over a non-secure network from the Router Map Discovery Server.

8. The method of claim 1, wherein further comprising determining a destination IP address for the IP packet based on the SA.

9. A method implemented on a decryption device for providing transparent Ethernet frame adjacency for routers communicating over a network, the method comprising:
de-encapsulating a payload of a received IP packet to generate an encrypted partial Ethernet frame;
decrypting the encrypted partial Ethernet frame to generate a partial Ethernet frame;
determining a Medium Access Control (MAC) address of a source router and a MAC address of a destination router based on a Security Association (SA) indicated in the received IP packet; and
forming a new Ethernet frame, wherein forming the new Ethernet frame comprises appending the determined MAC address of the source router and the determined MAC address of the destination router to the partial Ethernet frame.

10. The method of claim 9, further comprising:
receiving a discovery message over a non-secure network requesting a response from an adjacent router;
forwarding the discovery request to the destination router;
receiving a discovery response from the destination router; and
sending the discovery response over the network with IP encryption on behalf of the destination router.

11. The method of claim 10, wherein the discovery message is an Open Shortest Path First (OSPF) Hello message and the discovery response comprises a Database Description (DBD) packet.

12. The method of claim 9, wherein a header of the new Ethernet frame includes a Multiprotocol Label Switching (MPLS) label generated by the source router.

13. The method of claim 9, wherein forming the new Ethernet frame further comprises computing a checksum for the new Ethernet frame and including the checksum in the new Ethernet frame.

14. The method of claim 13, further comprising sending the new Ethernet frame to the destination router.

15. The method of claim 9, wherein the decryption device is an Internet Protocol Security (IPSec) encryption gateway or a High Assurance Internet Protocol Encryptor (HAIPE®) gateway.

16. The method of claim 9, further comprising:
determining a destination router IP address for the destination router; and
sending a registration message including the destination router IP address, the MAC address of the destination router, and a secure IP address of the decryption device to a Router Map Discovery Server.

17. The method of claim 16, further comprising receiving mapping information for at least one router on a secure subnet that communicates over the network with IP encryption from the Router Map Discovery Server.

18. The method of claim 17, wherein the mapping information includes a secure IP address for an encryption/decryption device on the same secure subnet as at least one router, an IP address for at least one router, and a MAC address for the at least one router.

19. The method of claim 9, wherein the IP packet is Encapsulating Security Payload (ESP) formatted, and the SA is included in a Security Parameters Indicator (SPI) field.

20. A decryption device configured to provide transparent Ethernet frame adjacency for routers communicating over a non-secure network, the device comprising:
a secure communication interface;
a non-secure communication interface; and
a processor configured to:
de-encapsulate a payload of an IP packet received via the non-secure interface to produce an encrypted partial Ethernet frame;
decrypt the encrypted partial Ethernet frame to produce a partial Ethernet frame;
determine a Medium Access Control (MAC) address of a source router and a MAC address of a destination router based on a Security Association (SA) indicated in the received IP packet; and
form a new Ethernet frame by appending the determined MAC address of the source router and the determined MAC address of the destination router to the partial Ethernet frame.

21. The device of claim 20, wherein the device demarcates an interface between a secure network and the non-secure network, the secure communication interface is configured to communicate plaintext (PT) messages over the secure network, and the non-secure communication interface is configured to communicate ciphertext (CT) messages over the non-secure network.

22. The device of claim 21, wherein the CT messages communicated over the non-secure network are encrypted using an Internet Protocol Security (IPsec) encryption or a High Assurance Internet Protocol Encryptor (HAIPE®) protocol.

23. The device of claim 20, wherein the processor is further configured to:
receive a discovery request over the non-secure network via the non-secure interface, the discovery message requesting a response from an adjacent router;
forward the discovery request to the destination router via the secure interface;
receive a discovery response from the destination router via the secure interface; and
send the discovery response over the non-secure network on behalf of the destination router.

24. The device of claim 23, wherein the discovery message is an Open Shortest Path First (OSPF) Hello message and the discovery response comprises a Database Description (DBD) packet.

25. The device of claim 20, wherein the processor is further configured to:
negotiate the SA with an encryption device; and
associate the MAC address of the source router and the MAC address of the destination router with the SA.

26. The device of claim 25, wherein the processor is configured to determine the MAC address of the source router further based on a source IP address of the IP packet.

27. The device of claim 26, wherein the source IP address of the IP packet is a non-secure IP address of an encryption device, wherein the processor is further configured to determine a secure IP address of the encryption device based on the SA.

28. A method implemented in a communication system for performing Open Systems Interconnection (OSI) Layer 3 encryption/decryption that is transparent to OSI Layer 2 services, the method comprising:
de-encapsulating a payload of a received OSI Layer 3 packet to produce a partial OSI Layer 2 frame;
determining a OSI Layer 2 address of a non-adjacent communication device and a OSI Layer 2 address of a destination device based on a Security Association (SA) indicated in the received OSI Layer 3 packet;
forming a new OSI Layer 2 frame, wherein forming the new OSI Layer 2 frame comprises appending the determined OSI Layer 2 address of the non-adjacent originating communication device and the determined OSI Layer 2 address of the destination device to the partial OSI Layer 2 frame; and
transmitting the new OSI Layer 2 frame to a destination device, wherein the new OSI Layer 2 frame is identical to an OSI Layer 2 frame originated from the non-adjacent communication device.

29. The method of claim 28, wherein the received OSI Layer 2 frame is received via a non-secure network, wherein messages on the non-secure network are encrypted.

30. The method of claim 29, further comprising decrypting the partial OSI Layer 2 frame after de-encapsulation.

31. The method of claim 29, further comprising:
receiving a discovery message over the non-secure network requesting a response from an adjacent router;
forwarding the discovery request to the destination device via a secure subnet;
receiving a discovery response from the destination device via a secure subnet; and
sending the discovery response over the non-secure network on behalf of the destination device.

32. The method of claim 31, wherein the discovery message is an Open Shortest Path First (OSPF) Hello message and the discovery response comprises a Database Description (DBD) packet.

33. The method of claim 28, wherein the new OSI Layer 2 frame includes a Multiprotocol Label Switching (MPLS) label sent from the non-adjacent communication device.

34. The method of claim 28, further comprising negotiating with an encryption device to generate the SA.

35. A method for facilitating discovery of a first router over an Internet Protocol (IP) encrypted network implemented by an encryption/decryption device, the method comprising:
determining a first router IP address and a first router Medium Access Control (MAC) address for a first router; and
sending an IP encrypted registration message including the first router IP address, the first router MAC address, and a secure IP address of the encryption/decryption device to a Router Map Discovery Server.

36. The method of claim 35, wherein determining the first router IP address and the first router MAC address for the first router comprises:
sending a multicast request over a secure subnet requesting responses from routers with IP addresses on the secure subnet; and
receiving a response from the first router, wherein the response includes the first router IP address and the first router MAC address for the first router.

37. The method of claim 36, wherein the multicast request is an Internet Control Message Protocol (ICMP) router solicitation message.

38. The method of claim 35, wherein determining the first router IP address and the first router MAC address for the first router comprises receiving a multicast broadcast over a secure subnet including the first router IP address and the first router MAC address for the first router.

39. The method of claim 38, wherein the multicast broadcast is an Internet Control Message Protocol (ICMP) router advertisement message.

40. A method for discovering a first router over an Internet Protocol (IP) encrypted network implemented on an encryption/decryption device, the method comprising:
querying a Router MAP Discovery Server for information regarding routers in communicating over a non-secure network, wherein communications over the non-secure network are encrypted; and
receiving a response from the Router MAP Discovery Server, wherein the response includes a first router IP address for a first router, a first router Medium Access Control (MAC) address for the first router, and an IP address of IP layer encryption/decryption device acting as a gateway for the first router.

41. The method of claim 40, wherein the query is sent and the response is received over the non-secure network.

42. The method of claim 40, further comprising:
determining a second router IP address and a second router MAC address for a second router communicating on a secure subnet; and
sending an encrypted registration message including the second router IP address, the second router MAC address, and an IP address of the encryption/decryption device to the Router Map Discovery Server via the secure network, wherein the IP address of the encryption/decryption device is an IP address for communications via the secure subnet.

43. The method of claim 40, further comprising:
receiving a request for identification of adjacent routers from the second router over the secure subnet; and
sending a response including the first router MAC address of the first router.

44. The method of claim 43, wherein at least one of the request or response is an Address Resolution Protocol (ARP) packet.

45. The method of claim 43, wherein at least one of the request or the response is a Neighbor Discovery (ND) packet.

46. An encryption/decryption device configured to provide virtual gateway redundancy at a secure/non-secure interface, the device comprising:
a secure communication interface;
a non-secure communication interface; and
a processor configured to:
establish, for the secure interface, a plaintext (PT) Internet Protocol (IP) address, and
operate in one of a master state or a backup state.

47. The device of claim 46, wherein the processor is further configured to operate in the master state, wherein in the master state the processor is configured to forward messages received via a ciphertext (CT) IP address from a non-secure network to a router on the secure subnet.

48. The device of claim 47, wherein the processor is further configured to send a periodic heartbeat signal to the second encryption/decryption device.

49. The device of claim 46, wherein the processor is configured to operate in one of the master state or the backup state based on an election process with the second encryption/decryption device.

50. The device of claim 46, where in the processor is further configured to operate in the backup state, wherein in the backup state the processor is configured to monitor for receipt of a periodic heartbeat signal from the second encryption/decryption device.

51. The device of claim 50, wherein in the backup state, the processor is further configured to enter the master state on condition that the periodic heartbeat signal is not received from the second encryption/decryption device for a predetermined period of time.

52. The device of claim 46, where in the processor is further configured to operate in the backup state, wherein in the backup state the processor is configured to discard messages received via a ciphertext (CT) IP address from a non-secure network addressed to a router on the secure subnet.

53. An encryption/decryption device for providing end-to-end Quality of Service (QoS) over an Internet Protocol encrypted network, the device comprising:
a secure communication interface;
a non-secure communication interface; and
a processor configured to:
identify a routing label included in an Ethernet frame received via the secure communication interface,
encapsulate the received Ethernet frame in an Internet Protocol (IP) packet,
translate the routing label into a field in a header of the IP packet as part of a new Ethernet frame, and
transmit the new Ethernet frame over an IP encrypted network via the non-secure interface.

54. The device of claim 53, wherein the routing label identifies the IP packet as part of a packet stream.

55. The device of claim 53, wherein the routing label is a Multiprotocol Label Switching (MPLS) label.

56. The device of claim 53, wherein the processor is further configured to translate the MPLS label included in the received Ethernet frame to a flow label of the IP packet.

57. The device of claim 53, wherein the processor is further configured to translate the MPLS label included in the received Ethernet frame to a Differentiated Services Code Points (DSCP) field of the IP packet.

58. The device of claim 53, wherein the processor is further configured to:
receive a second Ethernet frame via the non-secure interface;
identify a flow label from a second IP packet that is included in a payload of the second Ethernet packet;
translated the flow label into a routing label in a third Ethernet frame.
